(19) United States
(12) Patent Application Publication
(10) Pub. No.: US 2012/0292062 A1
(43) Pub. Date: Nov. 22, 2012

(54) SYSTEMS AND METHODS FOR CONTROLLING DIESEL HAMMERS

(75) Inventor: John L. White, Kent, WA (US)

(73) Assignee: AMERICAN PILEDRIVING EQUIPMENT, INC., Kent, WA (US)

(21) Appl. No.: 13/474,575

(22) Filed: May 17, 2012

Related U.S. Application Data
(60) Provisional application No. 61/488,410, filed on May 20, 2011.

(51) Int. Cl. E02D 7/12; B25D 9/16; B25D 9/10

(52) U.S. Cl. 173/1; 173/128; 251/236

(57) ABSTRACT

A diesel hammer comprises a housing, an anvil, and a release valve. A combustion chamber is formed within the housing below the anvil. The release valve operates in a closed configuration in which fluid is substantially prevented from flowing out of the combustion chamber and an open configuration in which fluid is allowed to flow out of the combustion chamber through the release valve. The diesel hammer operates in a cycle mode in which the release valve is in the closed configuration and, when the anvil moves from an upper position to a lower position, the anvil compresses fluids within the combustion chamber and an interrupt mode in which the release valve is in the open configuration and, when the anvil moves from the upper position to the lower position, the anvil does not substantially compress the fluids within the combustion chamber.

### RELATED APPLICATIONS

This application claims benefit of priority of U.S. provisional patent application Ser. No. 61/488,410, filed May 20, 2011.

The entire contents of any application identified above are incorporated by reference herein.

### TECHNICAL FIELD

The present invention relates to methods and apparatus for inserting elongate members into the earth and, more particularly, to diesel hammers that create pile driving forces by combusting diesel fuel.

### BACKGROUND OF THE INVENTION

For certain construction projects, elongate members such as piles, anchor members, caissons, and mandrels for inserting wick drain material must be placed into the earth. It is well known that such rigid members may often be driven into the earth without prior excavation. The term “piles” will be used herein to refer to the elongate rigid members typically driven into the earth.

One system for driving piles is conventionally referred to as a diesel hammer. A diesel hammer employs a floating ram member that acts both as a ram for driving the pile and as a piston for compressing diesel fuel. Diesel fuel is injected into a combustion chamber below the ram member as the ram member drops. The dropping ram member engages an anvil member that transfers the load of the ram member to the pile to drive the pile. At the same time, the diesel fuel ignites, forcing the ram member and the anvil member in opposite directions. The anvil member further drives the pile, while the ram member begins a new combustion cycle.

Diesel hammers operate through a compression, ignition, and expansion cycle. This cycle is controlled primarily by controlling whether and how much fuel is injected into the compression chamber below the ram member. To stop the cycle, fuel flow to the injectors is cut off, preventing the flow of fluid into the compression chamber. However, the diesel hammer may cycle one, two, or more times before fuel flow into the compression chamber can be cut off. Under certain conditions, the additional cycling of the diesel hammer can cause damage to the diesel hammer system, can cause damage to the pile, and/or result in an improperly driven pile.

The need thus exists for improved diesel hammers that make it easier for the operator to prevent the further cycling after fuel to the combustion chamber is cut off.

### SUMMARY

The present invention may be embodied as a diesel hammer comprising a housing, an anvil, and a release valve. The housing defines a fuel port and an exhaust port. The anvil is arranged to move between upper and lower positions within the housing. A combustion chamber is formed within the housing below the anvil. The release valve arranged to operate in a closed configuration in which fluid is substantially prevented from flowing out of the combustion chamber and an open configuration in which fluid is allowed to flow out of the combustion chamber through the release valve. The diesel hammer operates in a cycle mode and an interrupt mode. In the cycle mode, the release valve is in the closed configuration and, when the anvil moves from the upper position to the lower position, the anvil compresses fluids within the combustion chamber. In the interrupt mode, the release valve is in the open configuration and, when the anvil moves from the upper position to the lower position, the anvil does not substantially compress the fluids within the combustion chamber.

The present invention may also be embodied as a method of driving a pile comprising the following steps. A housing defining a fuel port and an exhaust port is provided. The housing is operatively connected the housing to the pile. An anvil is arranged for movement between upper and lower positions within the housing. A combustion chamber is formed within the housing below the anvil. A release valve is provided. The release valve operates in a closed configuration and an open configuration. The release valve is supported on the housing such that, when the release valve is operated in the closed configuration, fluid is substantially prevented from flowing out of the combustion chamber and, when the release valve is operated in the open configuration, fluid is allowed to flow out of the combustion chamber through the release valve. The release valve is operated in the closed configuration to place the diesel hammer in a cycle mode in which, when the anvil moves from the upper position to the lower position, the anvil compresses fluids within the combustion chamber. The release valve is operated in the open configuration to place the diesel hammer in an interrupt mode in which, when the anvil moves from the upper position to the lower position, the anvil does not substantially compress the fluids within the combustion chamber.

The present invention may also be embodied as a release valve for a diesel hammer defining a combustion chamber, the release valve comprising a valve member, a base member, a biasing member, and a lever member. The base member supports the valve member for movement between a closed position and an open position. The biasing member applies a biasing force on the valve member that biases the valve member towards the closed position. The base member supports the lever member for movement between first and second positions. The lever member engages the valve member such that the release valve is in the closed configuration when the lever member is in the first position and the release valve is in the open configuration when the lever member is in the second position. The valve member engages the base member to prevent flow of fluid from the combustion chamber when the valve member is in the closed position. The valve member is disengaged from the base member to allow flow of fluid from the combustion chamber when the valve member is in the open position.

### BRIEF DESCRIPTION OF THE DRAWINGS

FIGS. 1A-1G are schematic sectional views depicting the combustion/drive cycle of an example diesel hammer of the present invention;

FIG. 2 is a top plan, partial section view illustrating a first example release valve that may be used by the example diesel hammer system depicted in FIGS. 1A-1G;

FIG. 3 is a side elevation view of the first example release valve depicted in FIG. 2;

FIG. 4 is a section view taken along lines 4-4 in FIG. 3;

FIG. 5 is a section view depicting the first example release valve depicted in FIG. 2 in a closed configuration;

FIG. 6 is a section view depicting the first example release valve depicted in FIG. 2 in an open configuration;

FIG. 7 is a side elevation, partial section view illustrating a second example release valve that may be used by the example diesel hammer system depicted in FIGS. 1A-1G, the second example release valve being depicted in a closed configuration; and

FIG. 8 is a side elevation, partial section view illustrating the second example release valve in an open configuration.

### DETAILED DESCRIPTION OF THE INVENTION

The first section of the following discussion will describe the basic construction and operation of an example diesel hammer system 20 constructed in accordance with, and embodying, the principles of the present invention. The next section will be a detailed discussion of a first example release valve that may be used by the example diesel hammer system 20. The third section will contain a discussion of a second example release valve that may be used by the example diesel hammer system 20.

### I. EXAMPLE DIESEL HAMMER SYSTEM

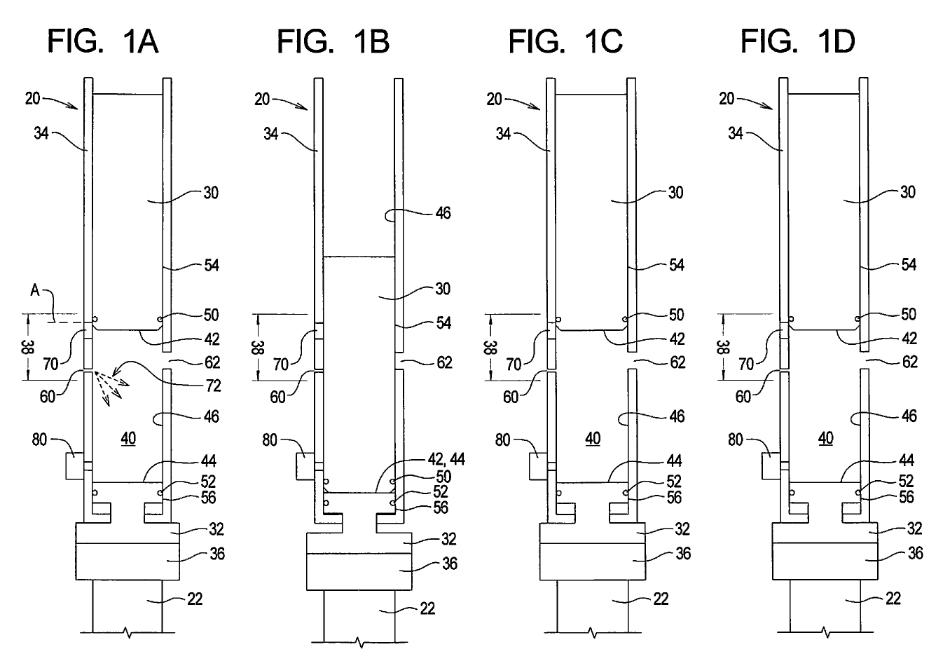

Turning to the drawing, depicted at 20 in FIGS. 1A-1G is a diesel hammer system that may use a release valve constructed in accordance with, and embodying, the principles of the present invention. The diesel hammer system 20 is designed to insert a pile 22 into the ground. The diesel hammer system 20 will include a spotter, crane, or other equipment as necessary to hold the hammer system 20 in a desired orientation with respect to the ground. Such structural components of the hammer system 20 are conventional and will not be described herein.

The diesel hammer system 20 comprises a ram member 30, an anvil member 32, a housing member 34, a clamp assembly 36, and a fuel injection system 38. The ram member 30 is guided by the housing member 34 for movement between a lower position (FIG. 1B) and an upper position (FIG. 1D). The anvil member 32 is guided by the housing member 34 for movement between a rest position (FIG. 1A) and an impact position (FIG. 1B). The anvil member 32 is rigidly connected to the clamp assembly 36. The clamp assembly 36 is detachably fixed relative to the pile 22.

A combustion chamber 40 is formed within the housing member 34 between a lower surface 42 of the ram member 30 and an upper surface 44 of the anvil member 32. Seals 50 and 52 are arranged in gaps 54 and 56 between an inner surface 46 of the housing member 34 and the ram and anvil members 30 and 32, respectively. When the seals 50 and 52 function properly, fluid is substantially prevented from flowing out of the combustion chamber 40 through these gaps 54 and 56.

A fuel port 60 and an exhaust port 62 are formed in the housing member 34. The fuel port 60 is arranged to allow the fuel injection system 38 to inject fuel into the combustion chamber 40. The exhaust port 62 is arranged to allow exhaust gases to be expelled from the combustion chamber 40 and to allow air to be drawn into the chamber 40.

The fuel injection system 38 comprises a pump lever 70. The pump lever 70 is biased into a ready position in which at least a portion of the pump lever 70 is within the housing member 34 (FIGS. 1E and 1F). When the ram member 30 drops below a trigger point A, the ram member 30 engages the pump lever 70 and moves the pump lever 70 from the ready position into a pump position (FIGS. 1A-1C). Forcing the pump lever 70 from the ready position into the pump position causes diesel fuel to be injected into the combustion chamber 40 through the fuel port 60.

The diesel hammer system 20 operates in an ignition cycle that will now be described with reference to FIG. 1. Referring initially to FIG. 1A, the hammer system 20 is shown in a pump state in which the ram member 30 is dropping and has forced the pump lever 70 from the ready position (FIGS. 1E and 1F) into the pump position (FIGS. 1A-1C). When the pump lever is forced from the ready position into the pump position, diesel fuel is injected as shown at 72 through the fuel port 60 into the combustion chamber 40 where it is mixed with air.

As the ignition cycle continues, the ram member 30 drops to a level where both the fuel port 60 and exhaust port 62 are covered by the ram member 30. At this point, the combustion chamber 40 is effectively sealed, and continued dropping of the ram member 30 compresses the air/fuel mixture within the combustion chamber 40.

Referring now to FIG. 1B, the hammer system 20 is shown in an impact state in which the lower surface 42 of the ram member 30 contacts the upper surface 44 of the anvil member 32. In the impact state, the ram member 30 drives the anvil member 32 towards the pile 22 relative to the housing member 34 as shown by a comparison of FIGS. 1A and 1B. The anvil member 32 thus drives the pile 22 downward through the clamp assembly 36. In addition, the housing member 34 will immediately fall onto the anvil member 32, thereby applying additional driving forces onto the pile member 22.

When the system 20 is in the impact state, the diesel fuel within the combustion chamber 40 ignites in the highly compressed air. The explosion resulting from the ignition of the air/fuel mixture forces the ram member 30 up and the anvil member 32 down. This explosion thus further drives the pile member 22 into the ground.

After the ignition occurs, the anvil member 32 is raised to an upper position as shown in FIG. 1C. As the anvil member 32 moves into the upper position, the lower end of the ram member 30 passes the fuel and exhaust ports 60 and 62. Expanding exhaust gases are thus forced out of the combustion chamber 40 through the exhaust port 62.

As the ram member continues on to its upper position, fresh air is drawn into the combustion chamber 40 through the exhaust port 62. In addition, the ram member 30 disengages from the pump lever 70. As soon as the ram member 30 disengages from the pump lever, the bias on the pump lever 70 returns the pump lever 70 to the ready position from the pump position and the fuel system 38 readies another quantity of fuel for the next cycle.

After the ram member 30 reaches the upper position as shown in FIG. 1E, the ram member 30 is allowed to drop again. The system 20 then enters a pre-injection state as shown in FIG. 1F. In the pre-injection state, the combustion chamber 40 is filled with fresh air and the fuel injection system 38 is primed to deliver another quantity of fuel. As the ram member 30 continues to drop, the system 20 enters the pump state as described with reference to FIG. 1A and the cycle begins again.

To interrupt the cycle, the diesel hammer system 20 is provided with a release valve 80 as illustrated in FIGS. 1A-F. The release valve 80 is attached to the housing member below the fuel port 60 and above the upper surface 44 of the anvil member 32 (e.g., FIGS. 1A, 1C, 1D, 1E, and 1F). In particular, the release valve 80 is configured to prevent the build-up of pressure within the combustion chamber 40 that will ignite any fuel within the chamber 40.

The release valve 80 is operable in an open configuration and a closed configuration. If the diesel hammer system 20 is operating in the ignition cycle mode, the release valve 80 is arranged in the closed configuration, and the diesel hammer system 20 will cycle through the operating modes associated with FIGS. 1A, 1B, 1C, 1D, and 1E as described above. To interrupt the ignition cycle and place the diesel hammer system 20 in a shut down mode, the release valve 80 is arranged in the open configuration as depicted in FIG. 1F.

When the release valve 80 is arranged in the open configuration, the diesel hammer system 20 enters a shut down mode, and the combustion chamber 40 is placed in fluid communication with the low pressure ambient air outside of the combustion chamber 40. The release valve 80 thus prevents compression and thus ignition of any diesel fuel within the combustion chamber 40. The ram member 30 will return to a rest state as depicted in FIG. 1G, but without ignition of the fuel cannot be driven upwardly into the pre-ignition state and thus cannot continue to cycle. The use of the release valve 80 thus allows the ram member 30 to impact the anvil member 32 at most one more time. And the last impact of the ram member during the shut down mode will be of lower impact because of the lack of the driving force associated with compression and ignition.

The supply of fuel to the fuel system 38 will typically be cut off at the same time as the release valve 80 is arranged in the open configuration, but fuel may continue to be injected as generally described above. However, with the release valve 80 arranged in the open configuration, ignition and combustion of any fuel within the combustion chamber 40 will be prevented.

### II. FIRST EXAMPLE RELEASE VALVE

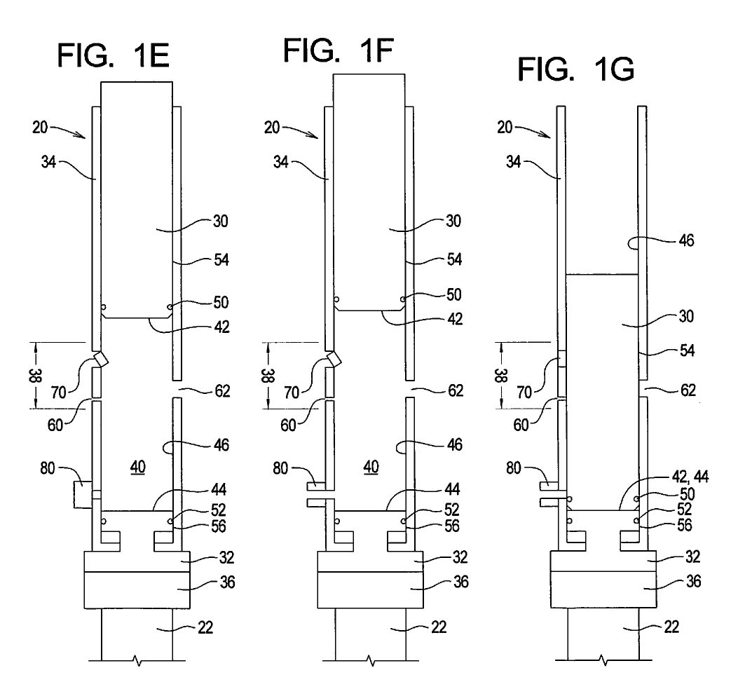

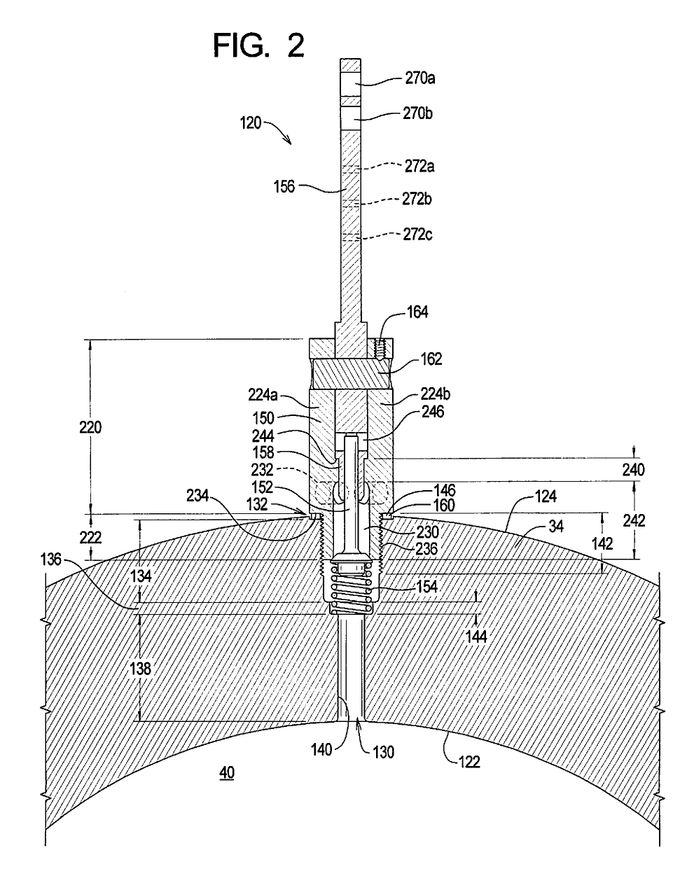

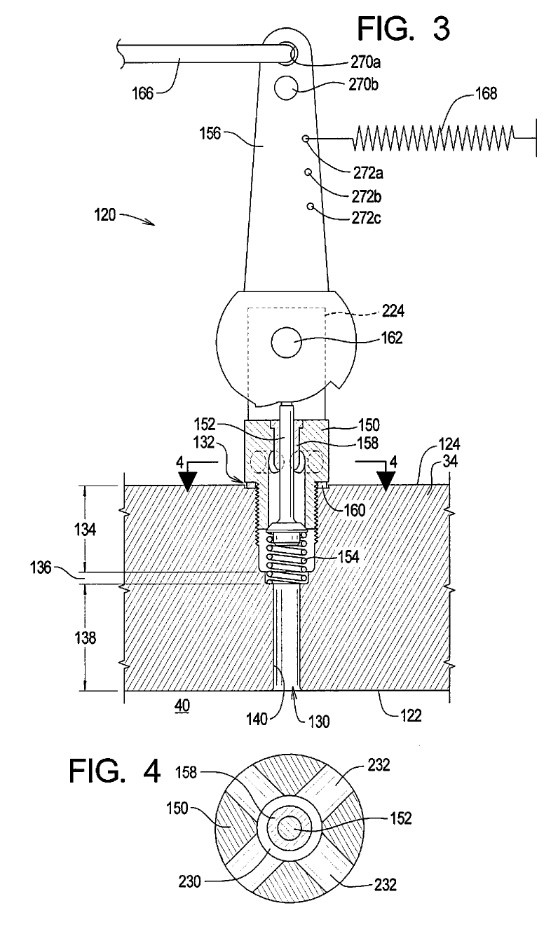

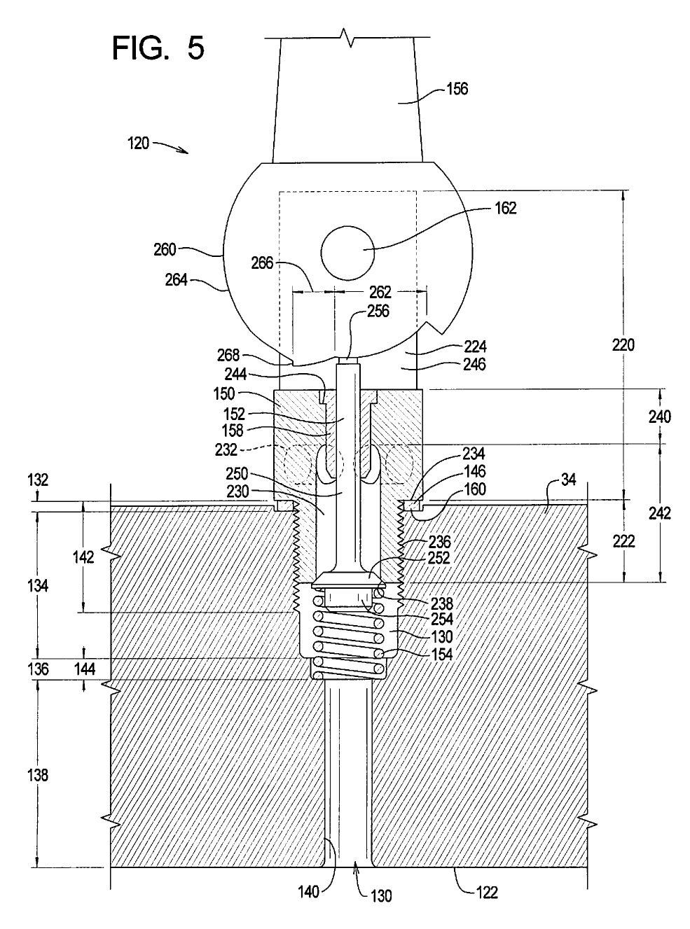

Referring now to FIGS. 2-6, depicted at 120 therein is a first example release valve that may be used as the release valve 80 described above. The example release valve 120 is adapted to be mounted to the housing member 34 as generally described above. The housing member 34 defines an inner surface 122 and an outer surface 124, and a housing bore 130 extends between the inner surface 122 and the outer surface 124. The example housing bore 130 defines first, second, third, and fourth portions 132, 134, 136, and 138. The housing bore 130 is defined by a bore surface 140 comprising a threaded portion 142, a retaining portion 144, and a gasket portion 146.

The first example release valve 120 comprises a base member 150, a valve member 152, a valve spring 154, a lever member 156, a guide member 158, a gasket 160, a pin member 162, a set screw 164, an actuator link 166, and a return spring 168.

The example base member 150 comprises a main portion 220, a bore portion 222, and first and second mounting flanges 224a and 224b. A valve bore 230 and a plurality of outlet bores 232 are formed in the base member 150. The base member 150 further defines a stop surface 234, a threaded surface 236, and a valve seat 238. The valve bore 230 comprises a guide chamber 240 and a valve chamber 242. The base 150 further defines a guide stop surface 244 and a cam space 246 arranged between the flanges 224a and 224b.

The example valve member 152 comprises a shaft portion 250, a valve portion 252, a retaining projection 254, and a lever portion 256. The example lever member 156 defines an operation surface 260 having first, second, third, and fourth portions 262, 264, 266, and 268. Actuator openings 270 and bias spring openings 272 are formed in the lever member 156.

The guide member 158 is arranged within the guide chamber 240 of the valve bore 230. The shaft portion 250 of the valve member 152 extends through the guide member 158 such that the lever portion 256 is within the cam space 246 and the valve portion 252 is within the valve chamber 242. The valve spring 154 is arranged in the valve chamber 242 and biases the valve member 152 such that the valve portion 252 is held against the valve seat 238. The gasket 160 is arranged substantially to prevent fluid flow through the housing bore 130 when the first example release valve 120 is closed.

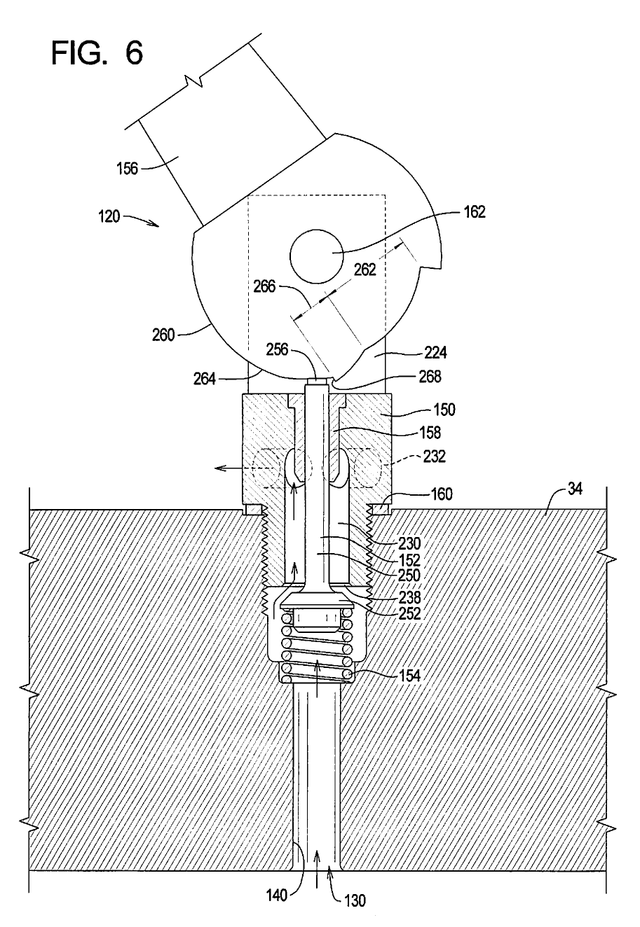

When the lever member 156 is arranged as shown in FIGS. 2, 3, and 5, the lever portion 256 is held against the first portion 262 of the operation surface 260, and the valve spring holds the valve portion 252 against the valve seat 238. By rotating the lever member 156 about the pin member 162 into the position depicted in FIG. 6, the lever portion 256 of the valve member 152 travels over the third and fourth portions 266 and 268 of the operation surface 260 and comes to rest against the second portion 264 of the operation surface 260. The distance from the axis of the pin member 162 and the second operation surface portion 264 is greater than the distance from the pin member axis and the first operation surface portion 262; the lever member 156 thus acts on the lever portion 256 such that the valve portion 252 is displaced away from the valve seat 238 as shown in FIG. 6. Fluid may thus flow out of the combustion chamber 40 through the valve bore 230 and outlet bores 232 when the lever member 156 is in the position shown in FIG. 6.

The actuator link 166 may be connected to a manual lever (not shown) by a cable or the like (not shown), or may be connected to a hydraulic, pneumatic, or electrical actuator (not shown) to allow remote control of the release valve 120. The return springs 168 inhibit inadvertent operation of the release valve 120.

### III. SECOND EXAMPLE RELEASE VALVE

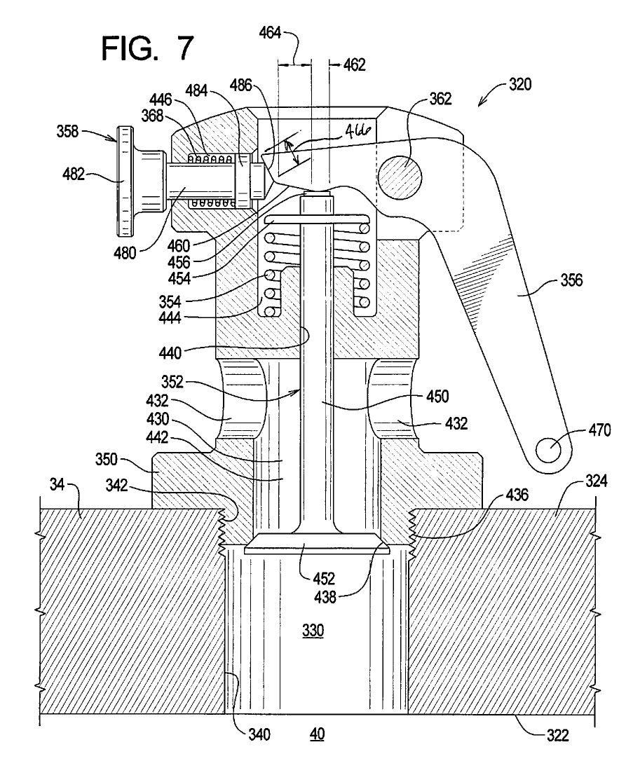

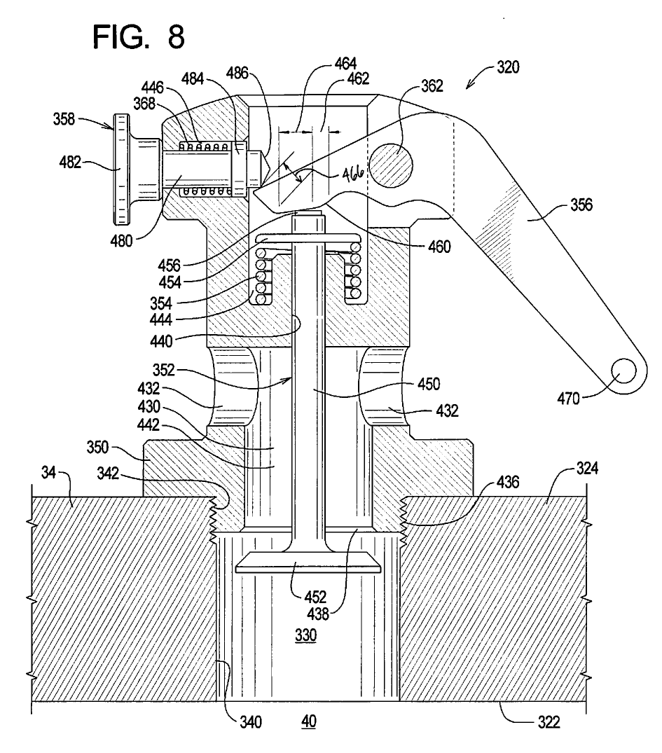

Referring now to FIGS. 7 and 8, depicted at 320 therein is a second example release valve that may be used as the release valve 80 described above. The example release valve 320 is adapted to be mounted to the housing member 34 as generally described above. The housing member 34 defines an inner surface 322 and an outer surface 324, and a housing bore 330 extends between the inner surface 322 and the outer surface 324. The example housing bore 330 is defined by a bore surface 340 comprising a threaded portion 342.

The second example release valve 320 comprises a base member 350, a valve member 352, a valve spring 354, a lever member 356, a latch member 358, a pin member 362, and a return spring 368.

A valve bore 430 and a plurality of outlet bores 432 are formed in the base member 350. The base member 350 further defines a threaded surface 436 and a valve seat 438. The valve bore 430 comprises a guide chamber 440 and a valve chamber 442. The base 350 further defines valve spring cavity 444 and a latch spring cavity 446.

The example valve member 352 comprises a shaft portion 450, a valve portion 452, a retaining projection 454, and a lever portion 456. The example lever member 356 defines an operation surface 460 defining first, second, and third portions 462, 464, and 466. An actuator opening 470 is formed in the example lever member 356. The latch member 358 comprises a shaft portion 480, a knob portion 482, a collar portion 484, and a latch surface 486.

The shaft portion 450 of the valve member 352 extends through the guide chamber 440 such that the lever portion 456 is adjacent to the operation surface 460 and the valve portion 452 is within the valve chamber 442. The valve spring 354 is arranged in the spring cavity 444 and biases the valve member 352 such that the valve portion 452 is held against the valve seat 438.

The base member 350 supports the latch member 358 for movement between a latched position as depicted in FIG. 7 and an unlatched portion as depicted in FIG. 8. The latch spring 368 is arranged to bias the latch member 358 into the unlatched position as generally described above.

When the lever member 356 is arranged as shown in FIG. 7, the valve spring 354 holds the lever portion 456 against the first portion 462 of the operation surface 460. The valve spring 354 thus acts on the valve member 352 such that the valve portion 452 of the valve member 352 is thus held against the valve seat 438. In its latched position, the latch member 358 engages the third portion 466 of the operation surface 460 of the lever member 356 to prevent inadvertent movement of the valve member 352 that would allow the valve spring 354 to displace the valve member 352 such that the valve portion 452 does not engage the valve seat 438.

By applying external rotational force on the lever member 356, the lever member 356 displaces the latch member 358 against the force of the latch spring 368 into the unlatched position, thereby allowing the lever member 356 to rotate about the pin member 362 into the open position depicted in FIG. 8. As the lever member 356 moves from the closed position (FIG. 7) to the open position (FIG. 8), the lever member 356 compresses the valve spring 354 such that the lever portion 456 of the valve member 352 thus travels from the first portion 462 to the second portion 464 of the operation surface 460.

The distance from the axis of the pin member 362 and the second operation surface portion 464 is greater than the distance from the pin member axis and the first operation surface portion 462. The lever member 356 thus acts on the lever portion 456 such that the valve portion 452 is displaced away from the valve seat 438 as shown in FIG. 8. Fluid may thus flow out of the combustion chamber 40 through the valve bore 430 and outlet bores 432 when the lever member 356 is in the position shown in FIG. 8.

The actuator opening 470 may be connected to a manual lever (not shown) by a cable or the like (not shown), or may be connected to a hydraulic, pneumatic, or electrical actuator (not shown) to allow remote control of the release valve 320.

When the lever member 356 is arranged such that the second portion 464 of the operation surface 460 is in contact with the lever portion 456, latch spring 368 displaces the latch member 358 into the unlatched position such that the lever member 356 is prevented from rotating back to allow the lever portion 456 to come into contact with the first portion 462 of the operation surface 460. By holding the lever portion 456 in contact with the second portion 464 of the operation surface 460, the latch member 358 prevents lever member 356 from allowing the valve portion 452 to be forced into contact with the valve seat 438, thereby holding the example release valve 320 in the open configuration. The latch member 358 thus holds the second example release valve 320 from inadvertently returning to the closed configuration.

To return the release valve 320 to the closed configuration, the knob portion 482 is grasped to displace the latch member 358 away from the base member 350 to allow the lever member 356 to be returned from the open position of FIG. 8 to the closed position of FIG. 7.

What is claimed is:

1. A diesel hammer comprising:
a housing defining a fuel port and an exhaust port;
an anvil arranged to move between upper and lower positions within the housing, where a combustion chamber is formed within the housing below the anvil; and
a release valve arranged to operate in
a closed configuration in which fluid is substantially prevented from flowing out of the combustion chamber, and
an open configuration in which fluid is allowed to flow out of the combustion chamber through the release valve; wherein
the diesel hammer operates in
a cycle mode in which the release valve is in the closed configuration and, when the anvil moves from the upper position to the lower position, the anvil compresses fluids within the combustion chamber; and
an interrupt mode in which the release valve is in the open configuration and, when the anvil moves from the upper position to the lower position, the anvil does not substantially compress the fluids within the combustion chamber.

2. A diesel hammer as recited in claim 1, in which:
fuel is disposed within the combustion chamber; and
when the diesel hammer operates in the cycle mode, the anvil compresses and ignites the fuel within the combustion chamber.

3. A diesel hammer as recited in claim 1, further comprising a pump lever, where, when the anvil moves from the upper position to the lower position, the anvil engages the pump lever to inject fuel into the combustion chamber through the fuel port.

4. A diesel hammer as recited in claim 1, in which:
a housing bore is formed in the housing to allow fluid flow between the combustion chamber and an exterior of the housing; and
the release valve comprises a valve member configured to prevent flow of fluid through the housing bore when the release valve operates in the closed configuration.

5. A diesel hammer as recited in claim 4, in which:
the release valve comprises a base member for supporting the valve member for movement between a closed position and an open position; and
the valve member engages the base member to prevent flow of fluid through the housing bore when the release valve operates in the closed configuration.

6. A diesel hammer as recited in claim 5, in which the release valve further comprises a biasing member for applying a biasing force on the valve member that biases the valve member towards the closed position.

7. A diesel hammer as recited in claim 5, in which:
the release valve further comprises a lever member;
the base member supports the lever member for movement between first and second positions; and
the lever member engages the valve member such that
the release valve is in the closed configuration when the lever member is in the first position, and
the release valve is in the open configuration when the lever member is in the second position.

8. A diesel hammer as recited in claim 5, in which:
the release valve further comprises a lever member;
the base member supports the lever member for movement between first and second positions; and
the lever member engages the valve member such that
the valve member is in the closed position when the lever member is in the first position, and
the lever member moves the valve member from the closed position to the open position when the lever member is moved from the first position to the second position.

9. A diesel hammer as recited in claim 6, in which:
the release valve further comprises a lever member;
the base member supports the lever member for movement between first and second positions; and
the lever member engages the valve member such that
the valve member is in the closed position when the lever member is in the first position, and
the lever member moves the valve member from the closed position to the open position against the biasing force applied by the biasing member when the lever member is moved from the first position to the second position.

10. A diesel hammer as recited in claim 7, in which the release valve is configured to inhibit movement of the lever member from the second position to the first position.

11. A diesel hammer as recited in claim 10, in which the lever member is configured to allow movement of the lever member from the first position to the second position and to inhibit movement of the lever member from the second position to the first position.

12. A diesel hammer as recited in claim 10, in which the release valve further comprises a latch member configured to engage the lever member to allow movement of the lever member from the first position to the second position and to inhibit movement of the lever member from the second position to the first position.

13. A method of driving a pile comprising the steps of:
providing a housing defining a fuel port and an exhaust port;
operatively connecting the housing to the pile;
arranging an anvil for movement between upper and lower positions within the housing, where a combustion chamber is formed within the housing below the anvil; and
providing a release valve that operates in a closed configuration and an open configuration;
supporting the release valve on the housing such that
when the release valve is operated in the closed configuration, fluid is substantially prevented from flowing out of the combustion chamber, and
when the release valve is operated in the open configuration, fluid is allowed to flow out of the combustion chamber through the release valve; and
operating the release valve in the closed configuration to place the diesel hammer in a cycle mode in which, when the anvil moves from the upper position to the lower position, the anvil compresses fluids within the combustion chamber; and
operating the release valve in the open configuration to place the diesel hammer in an interrupt mode in which, when the anvil moves from the upper position to the lower position, the anvil does not substantially compress the fluids within the combustion chamber.

14. A method as recited in claim 13, further comprising the step of injecting fuel within the combustion chamber such that, when the diesel hammer operates in the cycle mode, the anvil compresses and ignites the fuel within the combustion chamber.

15. A method as recited in claim 13, in which:
the step of providing the housing comprises the step of forming a housing bore in the housing to allow fluid flow between the combustion chamber and an exterior of the housing; and
the step of providing the release valve comprises the step of arranging a valve member to prevent flow of fluid through the housing bore when the release valve operates in the closed configuration.

16. A method as recited in claim 15, in which:
the step of providing the release valve comprises the step of providing a base member; and
the step of supporting the release valve on the housing comprises the steps of
supporting the base member on the housing; and
supporting the valve member for movement between a closed position and an open position relative to the base member such that the valve member engages the base member to prevent flow of fluid through the housing bore when the valve member is in closed position.

17. A method as recited in claim 15, in which the step of providing the release valve further comprises the step of arranging a biasing member to apply a biasing force on the valve member such that the valve member is biased towards the closed position.

18. A release valve for a diesel hammer defining a combustion chamber, the release valve comprising:
a valve member;
a base member for supporting the valve member for movement between a closed position and an open position;
a biasing member for applying a biasing force on the valve member that biases the valve member towards the closed position; and
a lever member, where the base member supports the lever member for movement between first and second positions; wherein
the lever member engages the valve member such that
the release valve is in the closed configuration when the lever member is in the first position, and
the release valve is in the open configuration when the lever member is in the second position;
the valve member engages the base member to prevent flow of fluid from the combustion chamber when the valve member is in the closed position; and
the valve member is disengaged from the base member to allow flow of fluid from the combustion chamber when the valve member is in the open position.

19. A release valve as recited in claim 18, in which the lever member is configured to allow movement of the lever member from the first position to the second position and to inhibit movement of the lever member from the second position to the first position.

20. A release valve as recited in claim 18, in which the release valve further comprises a latch member configured to engage the lever member to allow movement of the lever member from the first position to the second position and to inhibit movement of the lever member from the second position to the first position.
